(19) United States
(12) Patent Application Publication
(10) Pub. No.: US 2013/0271102 A1
(43) Pub. Date: Oct. 17, 2013

(54) POWER SUPPLY CONTROL STRUCTURE

(71) Applicant: Roger LIN, Taipei City (TW)

(72) Inventor: Roger LIN, Taipei City (TW)

(21) Appl. No.: 13/445,111

(22) Filed: Apr. 12, 2012

(51) Int. Cl. G05F 5/00

(52) U.S. Cl. 323/299

(57) ABSTRACT

A power supply control structure includes a voltage detection unit connected to a main power supply, a current control unit connected to the voltage detection unit, and switch units connected to different output points provided on the current control unit. The voltage detection unit detects a voltage value of the main power supply, the current control unit turns on one of the switch units via one of the output points according to the detected voltage value of the main power supply, so that loads respectively connected to the switch units always have the same output power even when the voltage value of the input main power supply is changed and batteries serving as the input main power supply can provide extended operating time.

### FIELD OF THE INVENTION

The present invention relates to a power supply control structure, and more particularly to a power supply control structure that enables a load to always have the same output power even when a voltage value of a main power supply is changed, and accordingly enables extended operating time of batteries serving as the main power supply.

### BACKGROUND OF THE INVENTION

In electric heating products, such as self-heating garments, that are driven to produce heat with one or more batteries, the operating time of the batteries plays a very important role. Therefore, it is desirable to work out a way for extending the operating time of the batteries without changing the output power of the products. Taking the commonly known self-heating garments as an example, two 3.7V batteries in series are usually used to provide a series voltage of 7.4V and to output fixed current and power. In the case three 3.7V batteries in series are used to provide a series voltage of 11.1V, or a nominal voltage of 12V, the output power increases with the increased voltage. That is, the use of three 3.7V batteries will produce more heat than using two 3.7V batteries but the three batteries provide a total operating time the same as that provided by only two batteries. More specifically, the battery operating time does not extend with the increased number of batteries being used. It is therefore tried by the inventor to develop an improved power supply control structure, which enables a load to always have the same output power even when the number of batteries serving as a main power supply is increased, so that the batteries can provide an extended operating time.

### SUMMARY OF THE INVENTION

A primary object of the present invention is to provide a power supply control structure, which enables a load to always have the same output power even when the voltage value of a main power supplies is changed. Therefore, when the number of batteries serving as an input main power supply is increased, the batteries can provide extended operating time due to the same output power of the load.

To achieve the above and other objects, the power supply control structure according to a preferred embodiment of the present invention includes a voltage detection unit connected to a main power supply, a current control unit connected to the voltage detection unit, and switch units separately connected to different output points provided on the current control unit. The voltage detection unit detects a voltage value of the main power supply, the current control unit turns on one of the switch units via one of the output points according to the detected voltage value of the main power supply, so that the load connected to any one of the switch units always has the same output power even when the voltage value of the input main power supply is changed and batteries serving as the input main power supply can provide extended operating time.

In the present invention, the voltage detection unit is a voltage comparator.

In the present invention, the current control unit is a control chip.

In the present invention, the switch units are transistors.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a circuit diagram of a power supply control structure according to a preferred embodiment of the present invention;

FIG. 2 shows a self-heating garment to which the power supply control structure according to the present invention is applied;

FIG. 3 shows a first example of the operation of the present invention; and

FIG. 4 shows a second example of the operation of the present invention.

### DETAILED DESCRIPTION OF THE PREFERRED EMBODIMENTS

The present invention will now be described with a preferred embodiment thereof and with reference to the accompanying drawings.

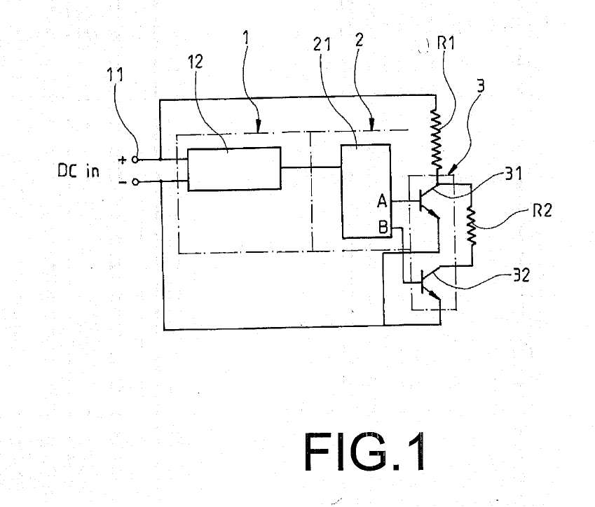

Please refer to FIG. 1 that is a circuit diagram of a power supply control structure according to a preferred embodiment of the present invention. As shown, the power supply control structure includes a voltage detection unit 1 connected to a main power supply 11, a current control unit 2 connected to the voltage detection unit 1, and switch units 3 connected to different output points of the current control unit 2.

The voltage detection unit 1 is a voltage comparator 12 connected to the main power supply 11, such as one or more batteries, for detecting a voltage value of the main power supply 11.

The current control unit 2 is a control chip 21 having at least two output points A and B, as shown in FIG. 1.

The switch units 3 include a first transistor 31 and a second transistor 32. In the illustrated preferred embodiment, the first and the second transistor 31, 32 have their respective base connected to the output points A and B, respectively. The first transistor 31 has a collector connected to a low-voltage load R1, which is a heating element for a self-heating garment in the illustrated embodiment. And, a high-voltage load R2, which can be another heating element, is connected to between collectors of the first and the second transistor 31, 32.

In the power supply control structure formed of the above-described components, the voltage detection unit 1 detects the exact voltage value of the main power supply 11, such as whether the main power supply includes two 3.7V batteries or three 3.7V batteries; and then the current control unit 2 turns on one of the switch units 3 via the output point A or B according to the detected voltage value of the main power supply 11. Therefore, by connecting the low-voltage load R1 and the high-voltage load R2 to the switch units 3, it is able to always have the same output power even when the voltage value of the main power supply 11 is changed. As a result, batteries serving as the main power supply 11 can provide extended operating time.

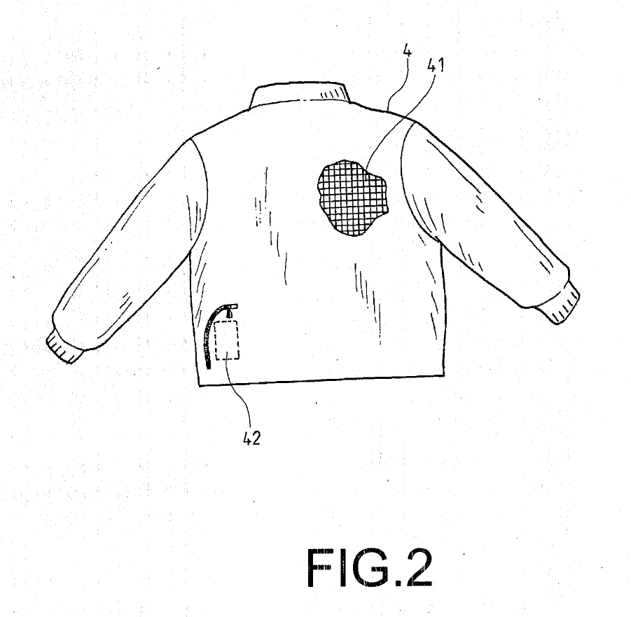

Please refer to FIG. 2, in which a self-heating garment 4 with the power supply control structure of the present invention is illustrated. As shown, the present invention can be used with a self-heating garment 4 provided with a heating element 41. The heating element 41 is connected to a battery case 42 and the power supply control structure of the present invention to obtain required power supply. With these arrangements, when the number of batteries in the battery case 42 is increased, the heating element 41 can still maintain at a fixed output power and the batteries can provide extended operating time.

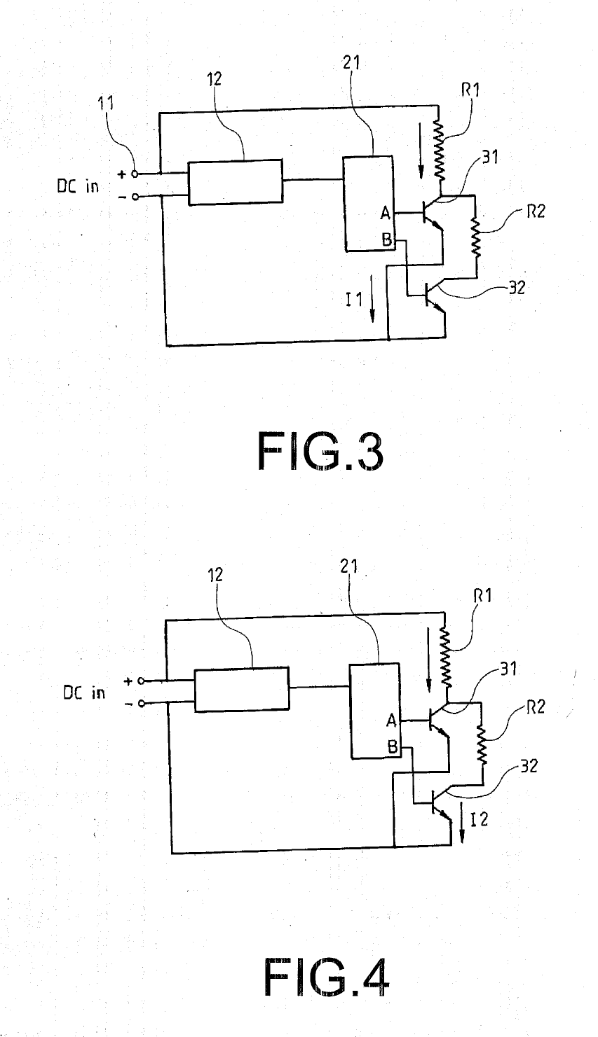

FIGS. 3 and 4 show two examples of the operation of the present invention. Please refer to FIGS. 3 and 4 along with FIGS. 1 and 2. When a main power supply 11 having a lower voltage value is selected for use and the voltage comparator 12 of the voltage detection unit 1 detects that the voltage value of the main power supply 11 is a low value, the control chip 21 of the current control unit 2 will then turn on the first transistor 31 of the switch unit 3 via the output point A and cut off the second transistor 32 accordingly. In this case, current I1 flows through the low-voltage load R1, i.e. the heating element 41. On the other hand, when a main power supply 11 having a higher voltage value is selected for use and the voltage comparator 12 of the voltage detection unit 1 detects that the voltage value of the main power supply 11 is a high value, the control chip 21 of the current control unit 2 will then turn on the second transistor 32 of the switch unit 3 via the output point B and cut off the first transistor 31 accordingly. In this case, current I2 flows through the low-voltage load R1 and the high-voltage load R2. That is, I2×(R1+R2)=I1×R1, and the same power is output.

According to the illustrated embodiment, when the main power supply 11 includes two 3.7V batteries, the circuit is that indicated by I1, the current flowing through the load R1 is about 1 A, and a heating temperature of about 60° C. can be reached. On the other hand, when the main power supply 11 includes three 3.7V batteries, the circuit is that indicated by I2, the current flowing through the loads R1 and R2 is about 0.8 A, and a heating temperature of about 55° C. can be reached. That is, the output powers (W) in the above two cases are substantially same, and the circuit 12 allows the batteries serving as the main power supply 11 with a higher voltage value to provide an extended operating time.

In brief, the present invention provides a power supply control structure that includes a voltage detection unit, a current control unit, and switch units connected to different output points of the current control unit. With the present invention, the load can always have the same output power even when the voltage value of the input main power supply is changed. Thus, when the number of batteries serving as the input main power supply is increased, an extended battery operating time can be obtained.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A power supply control structure, comprising:
a voltage detection unit connected to a main power supply for detecting a voltage value of the main power supply;
a current control unit connected to the voltage detection unit and having at least two output points, and turning on one of the output points according to the voltage value of the main power supply as detected by the voltage detection unit; and
a plurality of switch units separately connected to the at least two output points of the current control unit, and being turned on or cut off via respective connected output points according to the voltage value of the main power supply as detected by the voltage detection unit;
whereby loads respectively connected to the switch units always have the same output power even when the voltage value of the input main power supply is changed and batteries serving as the input main power supply can provide extended operating time.

2. The power supply control structure as claimed in claim 1, wherein the voltage detection unit is a voltage comparator.

3. The power supply control structure as claimed in claim 1, wherein the current control unit is a control chip.

4. The power supply control structure as claimed in claim 1, wherein the switch units are transistors.

5. The power supply control structure as claimed in claim 4, wherein the transistors respectively have a collector, and a high-voltage load is connected to between the two collectors.
